(19) United States
(12) Patent Application Publication
(10) Pub. No.: US 2006/0000060 A1
(43) Pub. Date: Jan. 5, 2006

(54) Hinge

(76) Inventors: Sheng-Nan Lu, Shulin City (TW); Hsiang-Chi Chien, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/872,374

(22) Filed: Jun. 22, 2004

(51) Int. Cl. E05C 17/64

(52) U.S. Cl. 16/340

(57) ABSTRACT

A hinge has a series of washer, a rotating device, a pivot shaft and a nut. The rotating device is mounted on a screen, and the pivot shaft is mounted on a base. The present invention provides a convenience for delivery of the LCD the screen can be folded parallel to the base.

### BACKGROUND OF THE INVENTION

1. Field of the Invention

The present invention relates to a hinge, especially to a hinge for a LCD whereby the LCD can be folded parallel to a base supporting the LCD.

2. Description of the Prior Arts

The rapid increase in popularity of LCD screens with computers has resulted in a corresponding demand for improvements in convenience of use of such screens. That is, the cathode ray had such size and weight it was virtually without variation in its position. The LCD screen opened up significant variations in positions of view. The LCD comprises a screen and a base. The conventional hinge is mounted between the screen and the base. The conventional hinge only can rotate the screen backward and forward to a small angle. The hinge keeps the screen standing upright. Then the contact surface of the upright screen is larger than that of a recumbent screen, and this will make the screen easily to be damaged when the contact surface is larger. Therefore when the LCD is shipping from a manufacturer to a retailer or moved from one desk to another, the screen is easy to be damaged.

To overcome the shortcomings, the present invention provides a hinge to mitigate or obviate the aforementioned problems.

### SUMMARY OF THE INVENTION

The main object of the present invention is to provide a hinge that can be folded to 90 degrees. The hinge comprises a series of washer, a rotating device, a pivot shaft and a nut. The series of washer has multiple fixed spacers, two rotating spacers, a biasing device and a washer. The rotating device has a circular hole and two protrusions. The pivot shaft has a fixed shaft, a penetrating shaft and a thread.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge in accordance of the present invention;

FIG. 2 is an exploded perspective view of the hinge in FIG. 1;

FIG. 3 is a side view of a LCD combined with two hinges in FIG. 1;

FIG. 4 is a side view of the hinge in FIG. 1 showing that the hinge is rotated backward;

FIGS. 5 and 6 are operational side views of the hinge in FIG. 1 showing that the hinge is rotated forward; and

FIG. 7 is a side view of the LCD in FIG. 3 showing that the LCD is rotated.

### DETAILED DESCRIPTION OF THE PREFERRED EMBODIMENTS

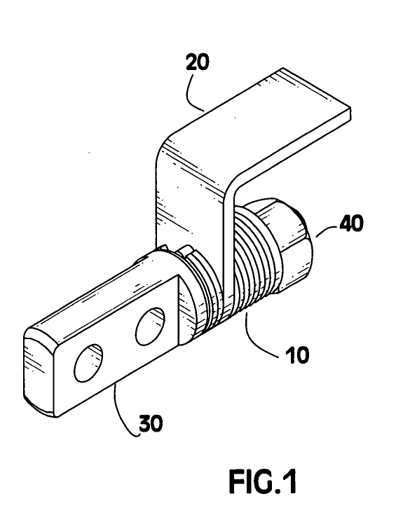

With reference to FIG. 1, a hinge in accordance with the present invention comprises a series of washer (10), a rotating device (20), a pivot shaft (30) and a nut (40).

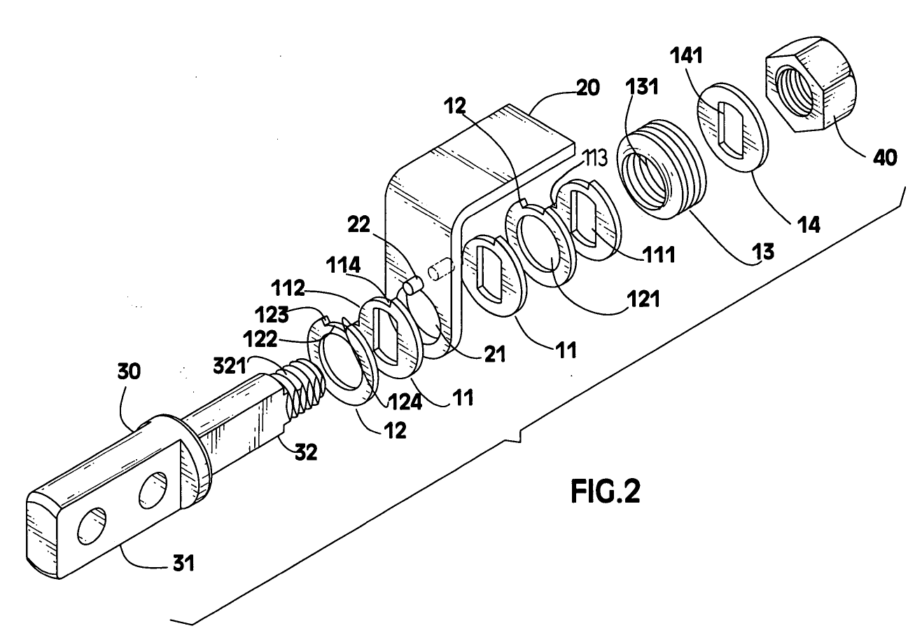

With further reference to FIG. 2, the series of washer (10) has three fixed spacers (11), two rotating spacers (12), a biasing device (13) and a washer (14).

Each fixed spacer (11) has a non-circular hole (111), an edge and a cut-out (112). The non-circular hole (111) is formed through each fixed spacer (11). The cut-out (112) is formed on the edge of each fixed spacer (11) and has a first end (113) and a second end (114). The cut-out (112) has a length.

Each rotating spacer (12) has a circular hole (121), an edge and a notch (122). The notch (122) is formed on the edge of each rotating spacer (12) and has a first end (123) and a second end (124). The notch (122) has a length. The length of the cut-out (112) of the fixed spacer (11) is longer than the length of the notch (122) of the rotating spacer (12).

The biasing device (13) has a circular hole (131) formed through the biasing device (13). The washer (14) has a non-circular hole (141) formed through the washer (14).

The rotating device (20) is an L-shaped pivot brake and has a distal end, a proximal end, a circular hole (21) and two protrusions (22). The proximal end is perpendicular to the distal end and has a first side and a second side. The circular hole (21) is formed through the proximal end. The protrusions (22) are formed respectively on the first side and the second side of the proximal end. The protrusions (22) are formed around the circular hole (21).

The pivot shaft (30) has a distal end, a proximal end, a fixed shaft (31), a penetrating shaft (32) and a thread (321). The fixed shaft (31) is formed on the distal end. The penetrating shaft (32) is formed on the proximal end and has a tip. The thread (321) is formed on the tip of the penetrating shaft (32).

When the series of washer (10) and the rotating device (20) are assembled, one of the fixed spacers (11) and one of the rotating spacers (12) are attached to the first side of the rotating device (20) and correspond to the circular hole (21) of the rotating device (20). One of the fixed spacers (11), one of the rotating spacers (12), the other fixed spacer (11), the biasing device (13) and the washer (14) are attached to the second side of the rotating device (20). The protrusions (22) extend into the respective cut-outs (112) and notches (122). Then the pivot shaft (30) is assembled with the series of washer (10) and the rotating device (20). The penetrating shaft (32) extends through the circular holes (121, 21, 131) of the rotating spacers (12), the rotating device (20) and the biasing device (13) and through the non-circular holes (111, 141) of the fixed spacers (11) and the washer (14). Then the nut (40) is screwed onto the thread (321) of the pivot shaft (30).

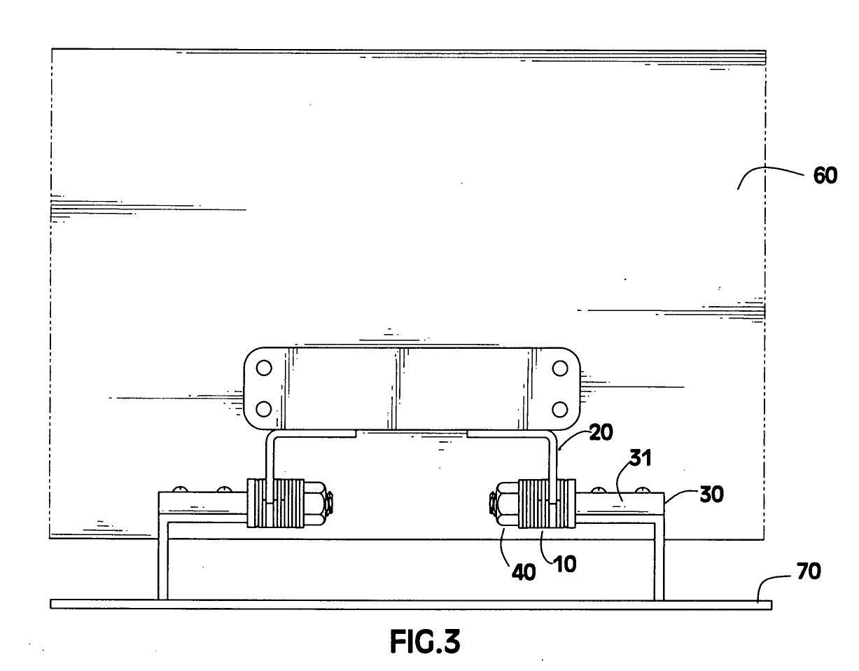

With further reference to FIG. 3, a liquid crystal display (LCD) comprises a screen (60) and a base (70). In this embodiment, two hinges are employed yet only one is referred to for the sake of brevity. The hinge is mounted between the screen (60) and the base (70). The distal end of the rotating device (20) is mounted on the screen (60). The fixed shaft (31) is mounted on the base (70).

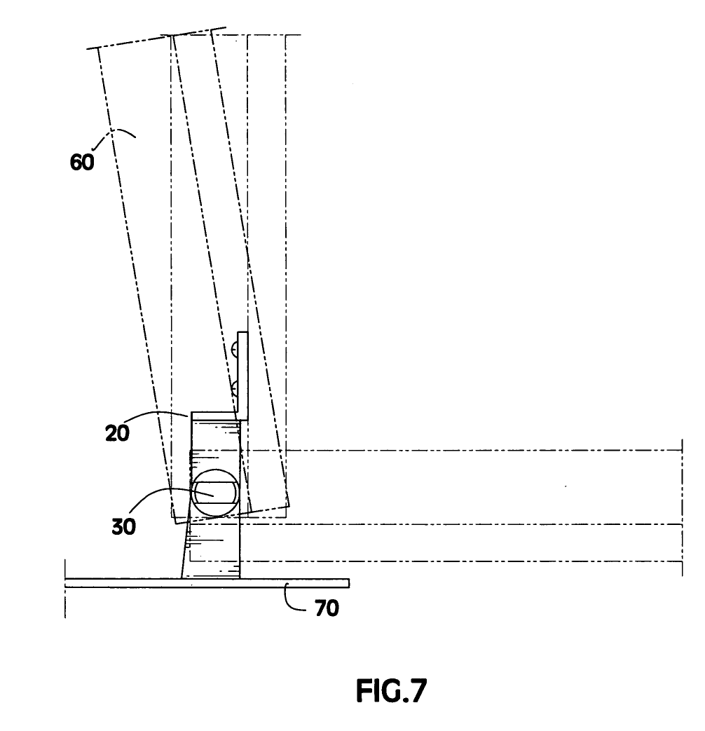

With further reference to FIG. 7, when the screen (60) is pivoted relative to the base (70), the rotating device (20) is rotated by the screen (60). The circular holes (22, 122) of the rotating device (20) and the rotating spacers (12) are circular. The non-circular holes (111) of the fixed spacers (11) and the penetrating shaft (32) are non-circular. When the rotating device (20) is rotated, the penetrating shaft (32) will prevent the fixed spacers (11) from rotation. The protrusions (22) of the rotating device (20) are moved along the respective cut-outs (112) and the notches (122) of the spacers (11, 12). When the protrusions (22) of the rotating device (20) abut the ends (123, 124) of the notches (122), the rotating spacers (12) will be rotated by the rotating device (20).

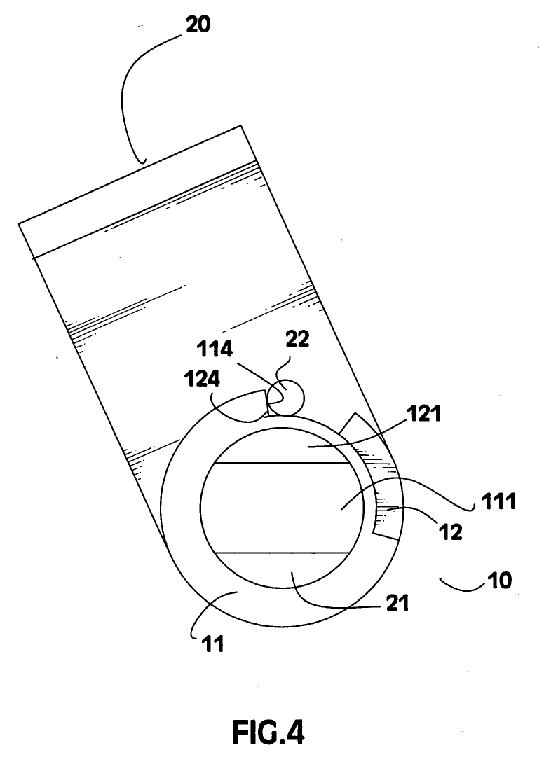

With further reference to FIG. 4, the screen (60) and the rotating device (20) are rotated backward. The protrusions (22) of the rotating device (20) abut against the second ends (114, 124) of the cut-outs (112) and the notches (122). Because the fixed spacers (11) cannot be rotated, the screen (60) and the rotating device (20) can only be rotated to a small degree.

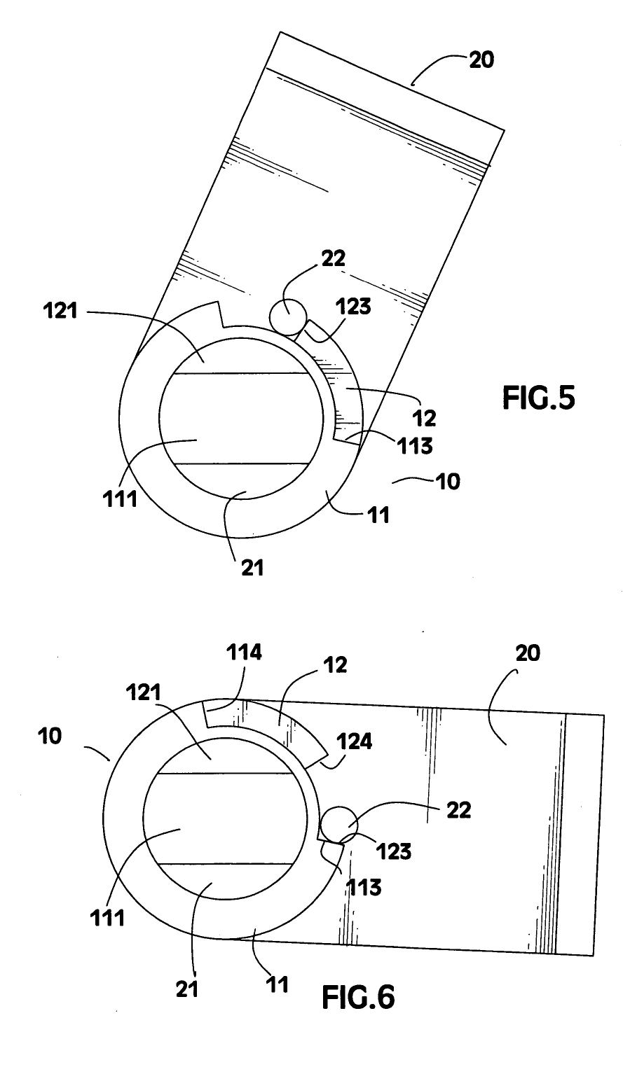

With further reference to FIG. 5, the screen (60) and the rotating device (20) are rotated forward. The protrusions (22) of the rotating device (20) abut against the first ends (123) of the notches (122). Then the screen (60) is positioned at this angle. With further reference to FIG. 6, the screen (60) and the rotating device (20) are exerted more strength to rotate further forward. The protrusions (22) abut against the first ends (123) and force the rotating spacers (12) to rotate. When the protrusions (22) abut against the first ends (113) of the cut-out (112), the rotating device (20) will be stopped from rotating. Then the screen (60) can be folded to be parallel to the base (70).

The hinge as described has a number of distinct advantages over a conventional hinge. The hinge can make the screen of the LCD to be folded to keep the screen (60) at a recumbent position. The contact surface of the recumbent screen is smaller than that of an upright screen, such that the recumbent screen (60) is not easily damaged when the LCD is shipping from a manufacturer to a retailer or moved from one desk to another. It is convenient for delivery of the LCD to fold the screen (60) to be parallel to the base (70). All components of the hinge are simple and easy to assemble.

Even though numerous characteristics and advantages of the present invention have been set forth in the foregoing description together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claim is:

1. A hinge comprising
a series of washer having
multiple fixed spacers wherein
each fixed spacer has non-circular hole formed through the fixed spacer,
an edge; and
a cut-out formed on the edge of the fixed spacer and having a first end and a second end;
multiple rotating spacers attached to the fixed spacers wherein each rotating spacer has
a circular hole formed through the rotating spacer,
an edge; and
a notch formed on the edge of the rotating spacer and having a first end and a second end;
a biasing device attached to the spacers and having a circular hole formed through the biasing device; and
a washer attached to the biasing device and having a non-circular hole formed through the washer;
a rotating device attached to the series of washer and having
a distal end;
a proximal end having
a first side attached to the series of washer; and
a second side;
a circular hole formed through the proximal end; and
at least one protrusion formed on the first end of the proximal end around the circular hole and moved along the cutouts and the notches of the spacers;
a pivot shaft extending through the rotating device and the series of washer and having
a distal end;
a proximal end;
a fixed shaft formed on the distal end;
a penetrating shaft formed on the proximal end, having an end and penetrating through the circular holes of the rotating spacers, the rotating device and the biasing device and through the non-circular holes of the fixed spacers and the washer; and
a thread formed on the end of the penetrating shaft; and
a nut screwed onto the thread of the pivot shaft.

2. The hinge as claimed in claim 1 wherein
the rotating device has two protrusions formed respectively on the first side and the second side of the proximal end, and is attached between the series of washer.

3. The hinge as claimed in claim 2, wherein
the series of washer has three fixed spacers and two rotating spacers;
one of the fixed spacers and one of the second spacers are attached to the first side of the proximal end of the rotating device; and
two of the fixed spacers and one of the second spacers are attached to the second side of the proximal end of the rotating device.
